(19) United States
(12) Patent Application Publication
(10) Pub. No.: US 2021/0061499 A1
(43) Pub. Date: Mar. 4, 2021

(54) PAYLOAD TIE-DOWN MECHANISM

(71) Applicant: Teledyne Brown Engineering, Inc., Huntsville, AL (US)

(72) Inventor: Ernest L. Thomas, III, Gurley, AL (US)

(21) Appl. No.: 16/551,714

(22) Filed: Aug. 26, 2019

(51) Int. Cl. B64G 1/64; F16M 13/02; B64G 1/10

(52) U.S. Cl. CPC B64G 1/641; B64G 1/105; F16M 13/02

(57) ABSTRACT

Systems and methods for payload attachment are disclosed. An example payload tie-down system includes a retaining stud assembly and a payload tie-down assembly. The payload tie-down assembly includes a tie-down housing and a tie-down fork. The tie-down for is movably enclosed within the tie-down housing. Additionally, the tie-down fork is configured to move linearly along an axis of the tie-down housing. The linear movement is generated by a rotational input to the payload tie-down assembly. Additionally, a first end of the tie-down fork is angled along at least a first axis.

### FEDERALLY SPONSORED RESEARCH OR DEVELOPMENT

This invention was made with government support under NNJ12GA21A awarded by the National Aeronautics and Space Administration (NASA). The government has certain rights in the invention.

### TECHNICAL FIELD

The present disclosure relates to connection devices, and in particular to a payload attachment mechanism.

### BACKGROUND

For some payloads, such as optical payloads, it may not be desirable to attach the payload to a larger system using fasteners that extend through the middle of the payload because such fasteners may block a portion of the optical path. Furthermore, operating an attachment mechanism for the payload over a distance from the attachment point may be desirable. Accordingly, systems and methods are described herein that allow for attachment without using fasteners through the middle of a payload and may be operated some distance from the attachment point.

### SUMMARY

Systems, methods, and devices for payload tie-down are described. Systems, methods, and devices may include a retaining stud assembly including a retaining stud and a payload tie-down assembly. The payload tie-down assembly may be configured to lock onto the retaining stud.

In an exemplary embodiment, a payload tie-down system includes a retaining stud assembly and a payload tie-down assembly. The payload tie-down assembly includes a tie-down housing and a tie-down fork. The tie-down fork is movably enclosed within the tie-down housing and configured to move linearly along an axis of the tie-down housing. The linear movement is generated by a rotational input to the payload tie-down assembly. A first end of the tie-down fork is angled along at least a first axis.

In an exemplary embodiment, a payload tie-down assembly includes a tie-down housing and a tie-down fork. The tie-down fork is movably enclosed within the tie-down housing and configured to move linearly along an axis of the tie-down housing. The linear movement is generated by a rotational input to the payload tie-down assembly. A first end of the tie-down fork is angled along at least a first axis.

In an exemplary embodiment, a method of a payload tie-down system includes providing a retaining stud assembly, and a payload tie-down assembly including a tie-down housing, and a tie-down fork movably enclosed within the tie-down housing and configured to move linearly along an axis of the tie-down housing, the linear movement generated by a rotational input to the payload tie-down assembly, a first end of the tie-down fork angled along at least a first axis. The method further includes positioning a payload attached to the tie-down housing and a device platform attached to a retaining stud of the retaining stud assembly such that the retaining stud is within the tie-down housing. The method also includes fastening the payload to the device platform by locking the payload tie-down assembly to the retaining stud.

The contents of this summary section are intended as a simplified introduction to the disclosure and are not intended to limit the scope of any claim.

### BRIEF DESCRIPTION OF THE DRAWINGS

With reference to the following description, appended claims, and accompanying drawings:

FIG. 1 is a diagram that illustrates a multiple user system for earth sensing (MUSES) that incorporates a retaining stud assembly, including a retaining stud in accordance with the systems and methods described herein.

FIG. 2 is a diagram that illustrates a retaining stud assembly in accordance with the systems and methods described herein.

FIG. 3 is a diagram that illustrates the MUSES hosted payload mechanical interfaces.

FIG. 4 is a diagram that illustrates a payload tie-down assembly in accordance with the systems and methods described herein.

FIG. 5 is another diagram illustrating the payload tie-down assembly of FIG. 4 in accordance with the systems and methods described herein.

FIG. 6 is a diagram that illustrates a fork in accordance with the systems and methods described herein.

FIG. 7 is a diagram that illustrates a payload tie-down mechanism in a retracted state in accordance with the systems and methods described herein.

FIG. 8 is a diagram that illustrates the payload tie-down assembly in an engaged state in accordance with the systems and methods described herein.

FIG. 9 is a diagram that illustrates a tie-down driver in accordance with the systems and methods described herein.

FIG. 10 is a diagram that illustrates a tie-down bushing in accordance with the systems and methods described herein.

FIG. 11 is a flow diagram illustrating a method in accordance with the systems and methods described herein.

### DETAILED DESCRIPTION

The following description is of various exemplary embodiments only and is not intended to limit the scope, applicability, or configuration of the present disclosure in any way. Rather, the following description is intended to provide a convenient illustration for implementing various embodiments, including the best mode. As will become apparent, various changes may be made in the function and arrangement of the elements described in these embodiments without departing from the scope of principles of the present disclosure.

The Payload Tie-Down Mechanism may secure a payload to the Retaining Stud after the payload is berthed to V-Guides, such as V-guides manufactured by Teledyne Brown Engineering (TBE) under license from MacDonald Dettwiler Space and Advanced Robotics Limited. The Payload Tie-Down Mechanism may be activated by an Orbital Replacement Unit (ORU) Tool Changeout Mechanism (OTCM) socket drive. A shaft may transmit rotation down through the payload base plate from the Modified Microfixture (MMF) into a right-angle gearbox. The gearbox may have an output shaft that may drive the Payload Tie-Down Mechanism. The Payload Tie-Down Mechanism may translate the Fork to capture the Retaining Stud and pull it up, e.g., 0.062″, thereby preloading the payload using, e.g., approximately 300 lbs. force to secure the payload in the V-Guides and to prevent gapping.

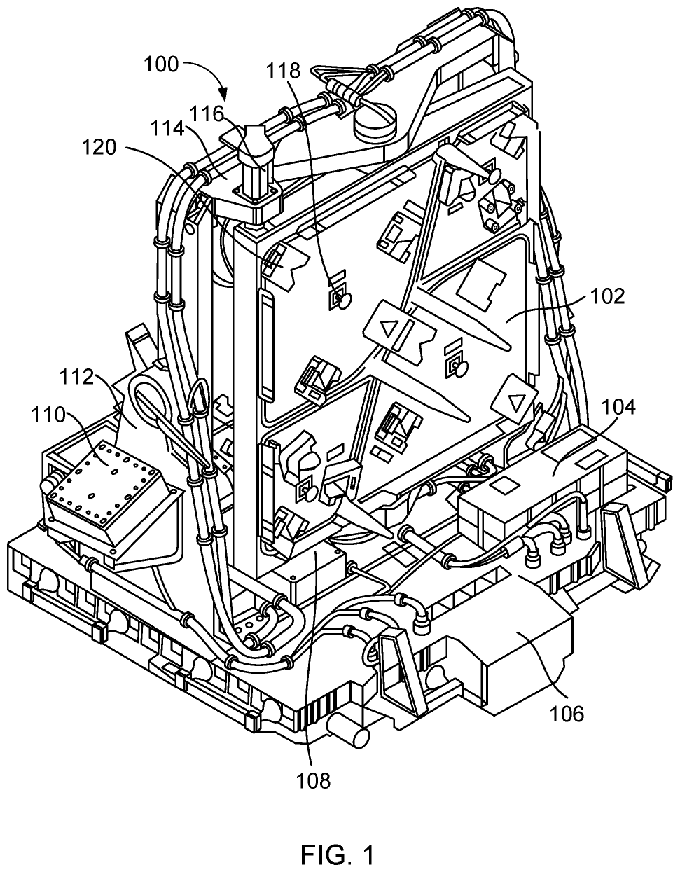

FIG. 1 is a diagram that illustrates a multiple user system for earth sensing (MUSES) 100 in a platform launch configuration that incorporates a retaining stud assembly including a retaining stud in accordance with the systems and methods described herein. The MUSES platform 100 launch configuration illustrated in FIG. 1 includes an inner gimble assembly 102, an Ethernet wireless controller (EWC) 104, an Expedite the Processing of Experiments to Space Station Rack (EXPRESS) Pallet Adapter (ExPA) 106, Electronic Control Unit (ECU) 108, wireless antenna 110, stanchion assembly 112, outer gimble 114, a launch lock 116, and female V-Guides 120.

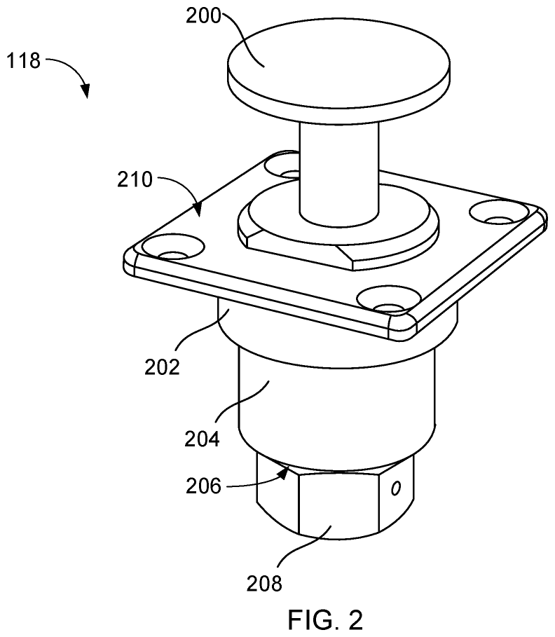

The MUSES platform 100 launch configuration illustrated in FIG. 1 also includes the Hosted Payload Retaining Stud Assembly 118. The Hosted Payload Retaining Stud Assembly 118 is one-half of the Payload Tie-Down Mechanism. The Hosted Payload Retaining Stud Assembly 118 is further illustrated in FIG. 2. The MUSES platform 100 may accommodate up to four Hosted Payloads in one example. Each Hosted Payload site may include one Hosted Payload Retaining Stud Assembly 118. The Hosted Payload Retaining Stud Assembly 118 includes a retaining stud. Each hosted payload that resides on the MUSES platform may be locked in place using the systems and methods described herein. The platform may provide the retaining stud. The systems and methods described herein may include a remotely operated tie-down mechanism that integrates and locks the payload to the retaining stud.

FIG. 2 is a diagram that illustrates a retaining stud assembly 118 in accordance with the systems and methods described herein. The retaining stud assembly 118 includes the retaining stud 200, a bushing 202 (below a mounting based 210) which mounts to the inner gimbal plate of the inner gimble assembly 102, a spring 204 (e.g., a number of Belleville disc springs in a series arrangement, in one example, ten disc springs), a flat washer 206, and a nut 208. In an example, the assembly may be preloaded to approximately 150 pounds by rotating the nut 208; the nut 208 may be secured by drilling a hole through both the nut 208 and the retaining stud of the retaining stud assembly 118 and installing a roll pin (not shown).

In an example, ten Belleville washers (which may form the spring 204) may be arranged in a series configuration will have an unloaded height of 0.76 inches and flattened height of 0.50 inches with a flattened spring force of 585 pounds. In an example, at nominal position, the fork may force the retaining stud up 0.062 inches beyond preload height which may result in a force of approximately 300 pounds to retain the hosted payload in the V-Guides. This may hold the MUSES payload securely based on-orbit loading, thermal variations, and manufacturing variations.

The retaining stud 200 may hold a hosted payload in the V-Guides by the tension force created by its springs (e.g., Belleville Springs). The stud and bushing may be made of CUSTOM 455 STAINLESS. Both the retaining stud 200 and bushing 202 may be lubricated by Vitro-lube. The retaining stud 200 may be threaded. In an example, the stud may have external 0.500-20 UNJF-3A threads.

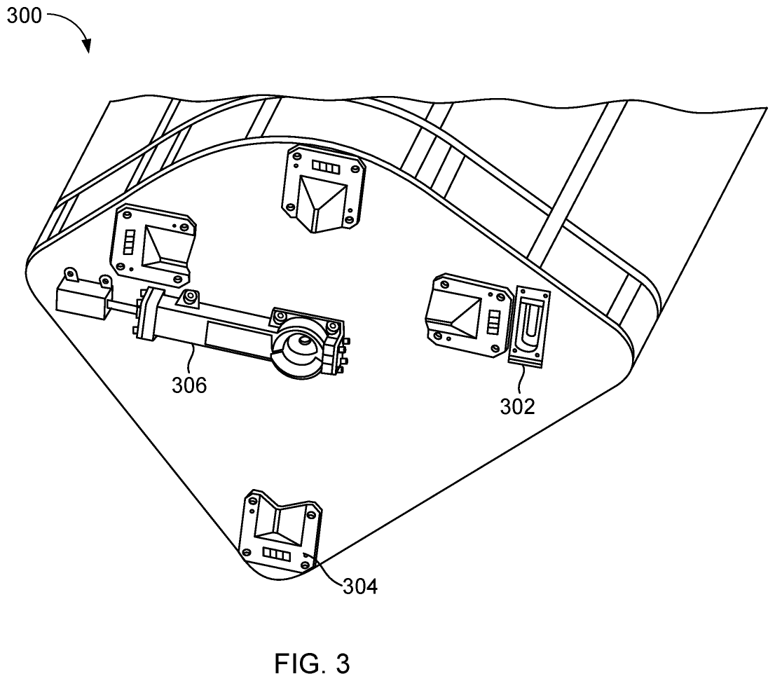

FIG. 3 is a diagram that illustrates the MUSES hosted payload 300 mechanical interfaces. As illustrated in FIG. 3 the MUSES to Hosted Payload Interfaces including the Tie-Down Mechanism, including blind mate connector 302, male V-Guides 304, and payload tie-down assembly 306. The MUSES hosted payload 300 of FIG. 3 may attach to the MUSES platform 100 of FIG. 1. For example, the payload tie-down assembly 306 may attach to the retaining stud 200 of FIG. 2. Additionally, the male V-Guides 304 may align with female V-Guides 120 on the MUSES platform 100 of FIG. 1. It will be understood that the male V-Guides 304 and the female V-Guides, 120 may be swapped. For example, in an example embodiment, the MUSES platform 100 may have male V-Guides, and the MUSES hosted payload 300 may have female V-Guides. Furthermore, in other example embodiments, different types of guides or no guides may be used.

One or more male guides 304 may each be configured to align with a corresponding female guide 120. In an example embodiment, the one or more male guide 304 may be attached to the payload. Accordingly, the corresponding female guide(s) may be attached to the device platform (e.g., MUSES platform 100). Alternatively, in another example embodiment, one or more female guides 120 may be attached to the payload. Accordingly, the corresponding male guides may be attached to the device platform (e.g., MUSES platform 100). In a third alternative embodiment, a mixture of male and female guides may be on the platform and the payload. A mixture of male guides and female guides may be used, as long as the locations of each guide on the payload have a corresponding location on the platform and male guides located on one device are paired to mate with female guides on the other device. Thus, the male guide(s) and the female guide(s) may, in various configurations, align payloads for attachment to the MUSES platform 100.

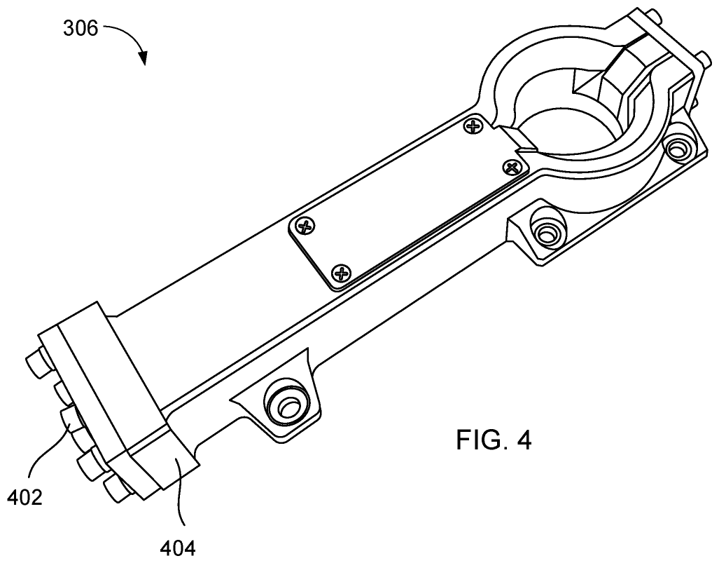

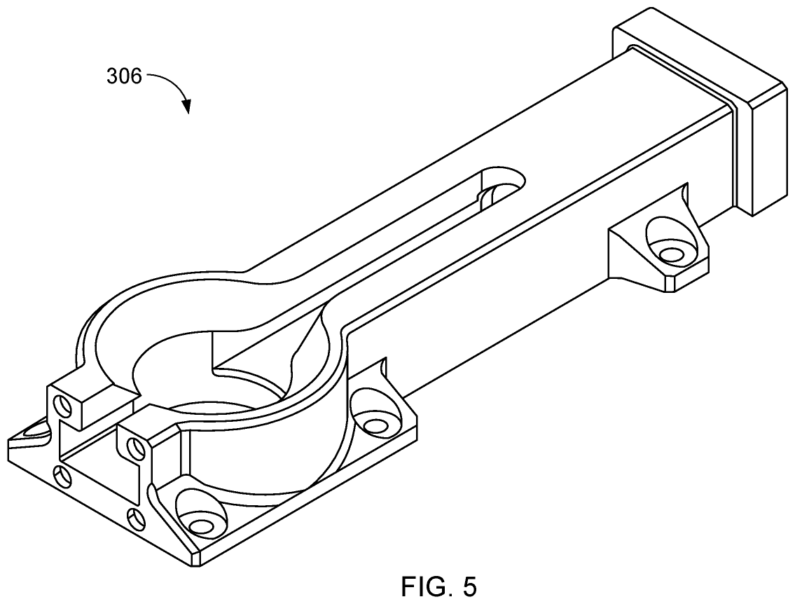

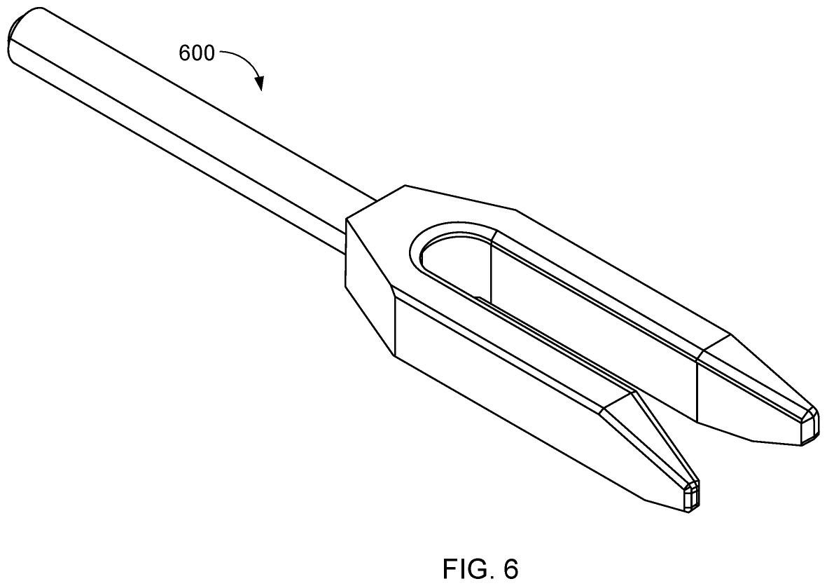

FIGS. 4 and 5 are diagrams that illustrate a payload tie-down assembly 306 in accordance with the systems and methods described herein. In an example embodiment, the payload tie-down assembly 306 will secure the payload to the retaining stud 200 after the payload is berthed to the V-Guides 120, 304. The payload tie-down assembly 306 may be activated by an OTCM socket drive. A shaft may transmit rotation down through the payload base plate from the MMF into a right-angle gearbox. The gearbox output shaft may drive the payload tie-down mechanism within the payload tie-down assembly 306 at rotational input 402. Rotation at 402 may move a tie-down fork 600 (FIG. 6) within a tie-down housing 404. The tie-down fork 600 may be used to engage the retaining stud 200.

FIG. 6 is a diagram that illustrates tie-down fork 600 in accordance with the systems and methods described herein. In an example embodiment, the fork may be made of dry film lubricated Inconel 718 with an external 0.375-24 UNJF-3A LH threads per AS8879 1 on one end and tapered fork on the other end. The Fork may be restrained from rotating by the rectangular shape of the tie-down housing 404 of the payload tie-down assembly 306.

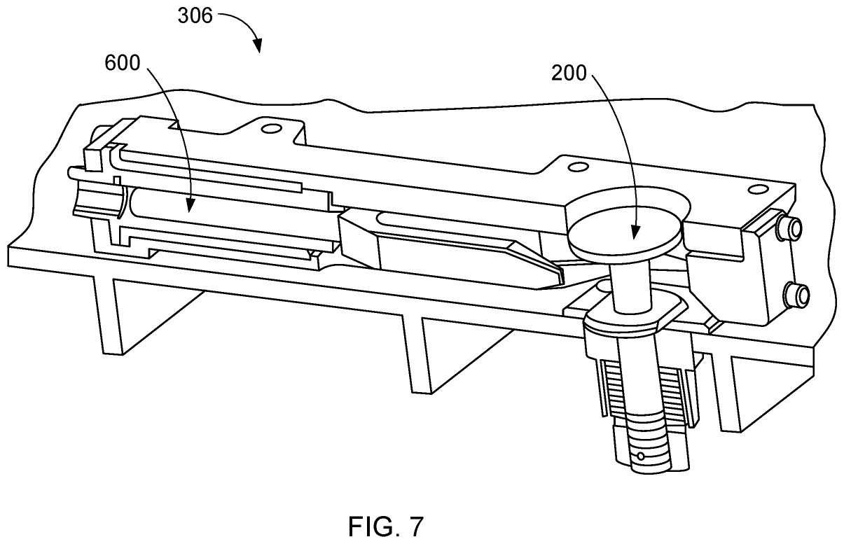

FIG. 7 is a diagram that illustrates a payload tie-down mechanism of the payload tie-down assembly 306 in a retracted state in accordance with the systems and methods described herein. Thus, the payload tie-down assembly 306 is illustrated in the retracted position in FIG. 7. In other words, tie-down fork 600 is retracted. Accordingly, the mechanism may be ready to latch.

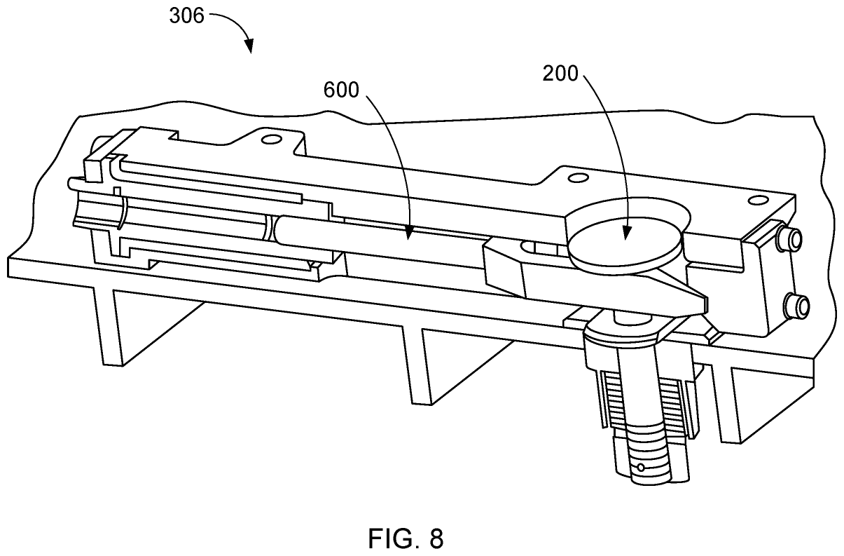

FIG. 8 is a diagram that illustrates the payload tie-down assembly in an engaged state in accordance with the systems and methods described herein. Thus, the payload tie-down assembly 306 is illustrated in the engaged position in FIG. 8. In other words, tie-down fork 600 is not retracted. The tie-down fork 600 is extended such that the Fork has captured the retaining stud 200 and pulled it up. As described herein, in an example, the retaining stud 200 may be pulled up 0.062″ and thereby preload the payload using approximately 300 pounds of force to secure the payload in the V-Guides and to prevent gapping. In an aspect, the mechanism may be thermal vacuum tested and functionally tested to ensure reliable operation in the space environment.

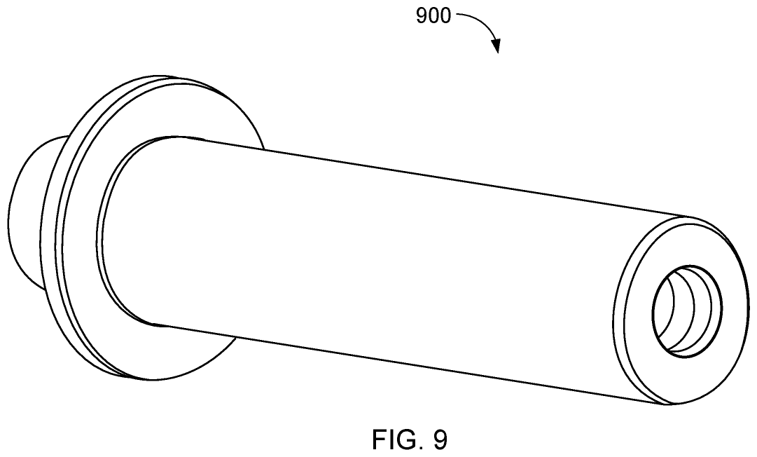

FIG. 9 is a diagram that illustrates a tie-down drive 900 in accordance with the systems and methods described herein. The tie-down drive 900 may convert rotary motion into linear motion. Accordingly, the tie-down drive 900 may convert rotary motion from the rotational input 402 into linear motion to move the tie-down fork 600. Thus, the tie-down fork 600 may be extended and retracted (linear motion) based on rotational motion to the rotational input 402. In an example embodiment, the tie-down drive 900 may convert rotational motion into linear motion using a screw thread. For example, the tie-down drive 900 may be free to move linearly and may be moved linearly when the drive's 900 threads are engaged with other threads that are fixed linearly. In one aspect, the tie-down drive 900 may rotate against the other threads. In another aspect, the tie-down drive 900 may be fixed, and the other threads may be rotated relative to the tie-down drive 900 to cause the drive to move linearly. In an example embodiment, the drive may be made of Custom 455 Stainless that is dry film lubricated. The tie-down drive 900 may have internal 0.375-24 UNJF-3B LH threads per AS8879.

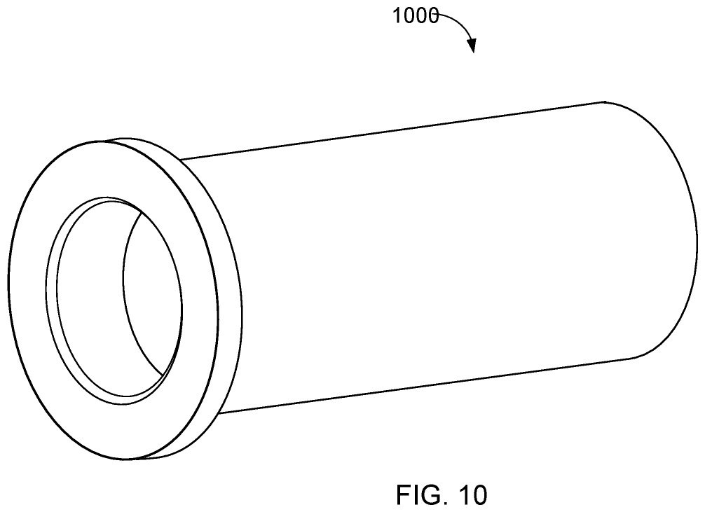

FIG. 10 is a diagram that illustrates a tie-down bushing 1000 in accordance with the systems and methods described herein. As discussed above, the tie-down drive 900 converts rotary motion into linear motion using a screw thread. In an aspect, the tie-down drive 900 rotates in a shoulder a tie-down bushing 1000. In an aspect, the tie-down bushing 1000 restrains the tie-down drive 900 from axial movement. In an example, the tie-down drive 900 rotates in the shoulder of the tie-down bushing 1000 such that the tie-down drive 900 is restrained from axial movement and the tie-down fork 600 may be moved linearly by corresponding sets of threads on the tie-down drive 900 and the tie-down fork 600. In another aspect, a separate piece may have the corresponding threads and may attach to the tie down tie-down fork 600. In an aspect, the busing 900 may be made of NITRONIC 60.

An example payload tie-down system may include a retaining stud assembly 118 and a payload tie-down assembly 306. The payload tie-down assembly 306 may include a tie-down housing 404 and a tie-down fork 600. The tie-down fork 600 may be movably enclosed within the tie-down housing 404. Additionally, the tie-down fork 600 may be configured to move linearly along an axis of the tie-down housing 404. The linear movement may be generated by a rotational input to the payload tie-down assembly 306. Additionally, a first end of the tie-down fork 600 may be angled along at least a first axis.

In an aspect, the first end of the tie-down fork 600 is angled along at least the first axis and a second axis for engagement of the retaining stud assembly 118 (e.g., at the retaining stud 200). The angles along the first axis and the second axis may be configured for engaging a misaligned payload to a retaining stud 200 of the retaining stud assembly 118. For example, the angles may allow for engagement of the tie-down fork 600 to the retaining stud 200 over a range of angles between the tie-down fork 600 and the retaining stud 200. Accordingly, when the payload is misaligned relative to the MUSES platform 100, it may still be possible to connect the payload according to the systems and methods described herein. The amount of misalignment that a system may compensate for may vary depending on the angle(s) on the tie-down fork 600, the size of the retaining stud 200, the spring tension on the stud, and other aspects of the particular implementation of the systems and methods described herein.

In an aspect, a second end of the tie-down fork 600 is substantially perpendicular to the retaining stud assembly. For example, the second end of the tie-down fork 600 may be substantially perpendicular to the retaining stud assembly when the payload tie-down assembly 306 is engaged with the retaining stud assembly 118.

In an aspect, the retaining stud assembly 118 includes a mounting base 210, a retaining stud 200, and a spring 204 coupling the stud to the mounting base 210. Accordingly, the retaining stud 200 may have one or more ranges of motion within the retaining stud assembly 118. For example, the retaining stud 200 may move linearly along an axis approximately perpendicular to the mounting base 210. The springs 204 may apply pressure to the tie-down fork 600 when the fork engages the retaining stud 200.

In an aspect, the linear movement of the tie-down fork 600 may be generated from rotational input using a tie-down driver. For example, the tie-down driver may include screw threads converting the rotational input to linear movement.

In an aspect, a retaining stud assembly 118 may be attached to a device platform such as the MUSES platform 100. The payload tie-down assembly 306 may be attached to a payload. Accordingly, the retaining stud assembly 118 and the payload tie-down assembly 306 may attach the device platform to the payload.

In an aspect, at least one male guide 304 may be configured to align with at least one female guide 120. One of the at least one male guide 304 or the at least one female guide 120 may be attached to the payload. Another of the at least one male guide 304 or the at least one female guide 120 may be attached to the device platform of the MUSES platform 100. Accordingly, the male guide and the female guide may align payloads for attachment to the MUSES platform 100.

In an aspect, device platform (e.g., MUSES platform) may be configured to host a plurality of payloads. For example, the MUSES platform 100 is configured to host four payloads. Thus, the MUSES platform 100 includes four retaining stud assembly 118 and four retaining studs 200. Each individual retaining stud 200 of the four retaining studs 200 may engage a separate payload. Each payload may have a payload tie-down assembly 306.

In an aspect, the payload tie-down system may further include a payload baseplate of the payload and a shaft configured to transmit rotational movement through the payload baseplate to the payload tie-down assembly.

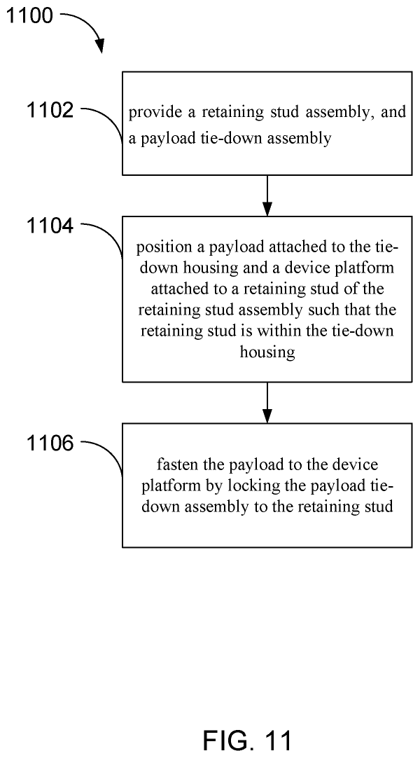

FIG. 11 is a flow diagram 1100 illustrating a method in accordance with the systems and methods described herein. The example method may be a method of a payload tie-down system. The method may include providing a retaining stud assembly, and a payload tie-down assembly including a tie-down housing, and a tie-down fork movably enclosed within the tie-down housing and configured to move linearly along an axis of the tie-down housing, the linear movement generated by a rotational input to the payload tie-down assembly, a first end of the tie-down fork angled along at least a first axis (step 1102).

The method may further include positioning a payload attached to the tie-down housing and a device platform attached to a retaining stud of the retaining stud assembly such that the retaining stud is within the tie-down housing (step 1104).

The method may also include fastening the payload to the device platform by locking the payload tie-down assembly to the retaining stud (step 1106).

An aspect may include, e.g., separate from the payload tie-down system, a payload tie-down assembly. The payload tie-down assembly may include a tie-down housing, and a tie-down fork movably enclosed within the tie-down housing and configured to move linearly along an axis of the tie-down housing, the linear movement generated by a rotational input to the payload tie-down assembly, a first end of the tie-down fork angled along at least a first axis.

The first end of the tie-down fork may be angled along at least the first axis and a second axis for engagement of a retaining stud assembly, the angles along the first axis and the second axis configured for engaging a misaligned payload to a retaining stud of the retaining stud assembly.

In an aspect, the second end of the tie-down fork is substantially perpendicular to a retaining stud assembly, when the payload tie-down assembly is engaged with the retaining stud assembly.

In an aspect, the linear movement is generated from the rotational input using a tie-down driver.

In an aspect, the tie-down driver includes screw threads converting the rotational input to linear movement.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims.

As used herein, the meaning of the term “non-transitory computer-readable medium” should be construed to exclude only those types of transitory computer-readable media which were found in In re Nuijten, 500 F.3d 1346 (Fed. Cir. 2007) to fall outside the scope of patentable subject matter under 35 U.S.C. § 101, so long as and to the extent In re Nuijten remains binding authority in the U.S. federal courts and is not overruled by a future case or statute. Stated another way, the term “computer-readable medium” should be construed in a manner that is as broad as legally permissible.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of embodiments encompassed by this disclosure. The scope of the claimed matter in the is accordingly to be limited by nothing other than the appended claims, in which reference to an element in the singular is not intended to mean “one and only one” unless explicitly so stated, but rather “one or more.”

Systems, methods, and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f), unless the element is expressly recited using the phrase “means for.” As used herein, the terms “comprises”, comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

When language similar to “at least one of A, B, or C” or “at least one of A, B, and D” is used in the claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed:

1. A payload tie-down system, comprising:
a retaining stud assembly; and
a payload tie-down assembly, including:
a tie-down housing, and
a tie-down fork movably enclosed within the tie-down housing and configured to move linearly along an axis of the tie-down housing, the linear movement generated by a rotational input to the payload tie-down assembly, a first end of the tie-down fork angled along at least a first axis.

2. The payload tie-down system of claim 1, wherein the first end of the tie-down fork is angled along at least the first axis and a second axis for engagement of the retaining stud assembly, the angles along the first axis and the second axis configured for engaging a misaligned payload to a retaining stud of the retaining stud assembly.

3. The payload tie-down system of claim 1, wherein a second end of the tie-down fork is substantially perpendicular to the retaining stud assembly, when the payload tie-down assembly is engaged with the retaining stud assembly.

4. The payload tie-down system of claim 1, wherein the retaining stud assembly comprises:
a mounting base;
a stud; and
a spring coupling the stud to the mounting base.

5. The payload tie-down system of claim 1, wherein the linear movement is generated from the rotational input using a tie-down driver.

6. The payload tie-down system of claim 5, wherein the tie-down driver includes screw threads converting the rotational input to linear movement.

7. The payload tie-down system of claim 1, wherein the retaining stud assembly is attached to a device platform and the payload tie-down assembly is attached to a payload, the retaining stud assembly and the payload tie-down assembly attaching the device platform to the payload.

8. The payload tie-down system of claim 7, further comprising at least one male guide configured to align with at least one female guide, one of the at least one male guide or the at least one female guide attached to the payload another of the at least one male guide or the at least one female guide attached to the device platform.

9. The payload tie-down system of claim 7, wherein the device platform is configured to host a plurality of payloads.

10. The payload tie-down system of claim 7, further comprising:
a payload baseplate of the payload; and
a shaft configured to transmit rotational movement through the payload baseplate to the payload tie-down assembly.

11. A payload tie-down assembly, comprising:
a tie-down housing, and
a tie-down fork movably enclosed within the tie-down housing and configured to move linearly along an axis of the tie-down housing, the linear movement generated by a rotational input to the payload tie-down assembly, a first end of the tie-down fork angled along at least a first axis.

12. The payload tie-down assembly of claim 11, wherein the first end of the tie-down fork is angled along at least the first axis and a second axis for engagement of a retaining stud assembly, the angles along the first axis and the second axis configured for engaging a misaligned payload to a retaining stud of the retaining stud assembly.

13. The payload tie-down assembly of claim 11, wherein a second end of the tie-down fork is substantially perpendicular to a retaining stud assembly, when the payload tie-down assembly is engaged with the retaining stud assembly.

14. The payload tie-down assembly of claim 11, wherein the linear movement is generated from the rotational input using a tie-down driver.

15. The payload tie-down assembly of claim 14, wherein the tie-down driver includes screw threads converting the rotational input to linear movement.

16. A method of a payload tie-down system, the method comprising:
providing a retaining stud assembly, and a payload tie-down assembly including a tie-down housing, and a tie-down fork movably enclosed within the tie-down housing and configured to move linearly along an axis of the tie-down housing, the linear movement generated by a rotational input to the payload tie-down assembly, a first end of the tie-down fork angled along at least a first axis;
positioning a payload attached to the tie-down housing and a device platform attached to a retaining stud of the retaining stud assembly such that the retaining stud is within the tie-down housing; and
fastening the payload to the device platform by locking the payload tie-down assembly to the retaining stud.
